(19) United States
(12) Patent Application Publication
(10) Pub. No.: US 2005/0226965 A1
(43) Pub. Date: Oct. 13, 2005

(54) Arctic wrap

(76) Inventor: John Michael Taylor, Valparaiso, IN (US)

Correspondence Address: John Michael Taylor, 601 Academy Street, Valparaiso, IN, 46383, US

(21) Appl. No.: 11/091,616

(22) Filed: Mar. 28, 2005

Related U.S. Application Data
(60) Provisional application No. 60/556,846, filed on Mar. 27, 2004.

(51) Int. Cl. B29D 11/00

(52) U.S. Cl. 426/115

(57) ABSTRACT

The thermal wrap is for beverage containers such as cups and pitchers of various sizes. A flexible cold pack that is tapered in a rectangular fashion and is made of poly carbonate, polystyrene, and or polyethylene. Injection molds of cells are used to retain de ionized water and or chemical agents, which conforms to the container shape that leaves an opening for condensation drainage. Fasteners provide secure hasp on cups and beverage pitchers that consist of Velcro that mates together to form a cylindrical structure around the exterior. An outer layer jacket made of expanse nylon sleeve to provide a protective barrier between the user hands and the cold temperature of the wrap.

### BACKGROUND OF THE INVENTION

Since I am a an avid sports fan, I frequent the sports bars and participate at professional sporting events. I have come to realize that by the time the concession vendors take the cold beverages out of their coolers and distribute them to the fans, the drinks tend to get warmer by the minute. There have been many instances throughout my life where I have ordered another cold drink due to the fact that the one I have is already becoming warm. Drink prices at collegiate and professional sporting events tend to be high in price, and having to waste a drink due to it losing its desired temperature is not feasible. I feel that this invention will allow drinks to remain cold, which will provide cost savings to the consumer. I am aware that there are products on the market which act as cooling devices, but some tend to take away from the desired volume the consumer expects to receive and may even leave a watery taste.

### SUMMARY OF THE INVENTION

This particular invention is equipped with a thin wall of resilient and or non resilient plastic that house injection molds. These molds are lined with refrigerant gels and or de ionized water. The product has rows of the injection molds which can be activated by breaking the particular strips, allowing the drink to decrease in temperature for a sufficient amount of time due to the chemical reaction that is underway. This application can be used in various setting such as sporting events, concerts, and or picnics ect . . . This particular product will have packages of ammonium nitrate and de ionized water which will reside in the injection molds, awaiting activation by snapping the cells like any conventional ice pack. The product does not need to be refrigerated and can be stored in dry conditions for long periods of time, until it is ready for use. The flexibility between the injection molds are approximately one eighth to a quarter inch apart, which allows the wrap to conform to the particular shape of the cup or pitcher. Both the hook and loop side of the wrap have Velcro which is held on by a non toxic adhesive.

Another application of the invention targets restaurants and bars. These establishments have easy access to refrigeration facilities. This product is fashioned in the same manner as previously stated, but the injection molds will be filled with a reusable non toxic refrigerant gel. When dealing with a pitcher the injection molds will be larger in scale as compared to a sixteen ounce cup.

### FIELD OF INVENTION

My Invention is a Thermal wrap for beverage cups and pitchers designed to provide cool beverages when desired by the consumer.

### CROSS RELATED REFERENCES

The following United States patents and/or other patent related documents (copies of which are provided with this reports) were discovered during the search appear to be similar, or at least possibly relevant, to the functional and/or design features of my invention:
1. U.S. Pat. No. 4,399,668 Inventor(s): Williamson Issue Date: Aug. 23, 1983.
2. U.S. Pat. No. 5,005,374 Inventor(s): Spitler Issue Date: Apr. 9, 1991.
3. U.S. Pat. No. 4,831,842 Inventor(s): Kelly et al. Issue Date: May 23, 1989.
4. U.S. Pat. No. 4,676,247 Inventor(s): Van Cleve Issue Date: Jun. 30, 1987.
5. U.S. Pat. No. 5,406,808 Inventor(s): Babb et al. Issue Date: Apr. 18, 1995.
6. U.S. Pat. Des. 393,591 Inventor(s): Gardner Issue Date: Apr. 21, 1998.
7. U.S. Pat. No. 6,412,300 Inventor(s): Kaposi Issue Date: Jul. 2, 2002.

### BRIEF DESCRIPTIONS OF DRAWINGS

FIG. 1. Is a perspective view showing the wrap and its sandwiching nylon sleeve conforming to cup.

FIG. 2. Is a fragmentary cross-sectional view of injection molds surrounding cup with nylon sleeve sandwiching the injection molds.

FIG. 3. Is a perspective view of an distinctive beverage pitcher container wrapped thereby with nylon sleeve barrier on a partial views of injection mold.

FIG. 4. Is a cross-sectional exploded side view of wrap and Velcro conforming to pitcher not interfering with handle.

FIG. 5. Is a exploded view of the backside of wrap further including loop of Velcro.

FIG. 6. Is a cross-sectional fragmentary side view of injection mold further including the wrap and the loop of Velcro.

FIG. 7. Is a cross-sectional fragmentary side view of wrap further including injection mold and hook of Velcro.

FIG. 8. Is a perspective view of the beverage wrap exposed side showing multitudes of injection further including the hook of Velcro.

### DETAILED DESCRIPTION OF EMBODIMENT

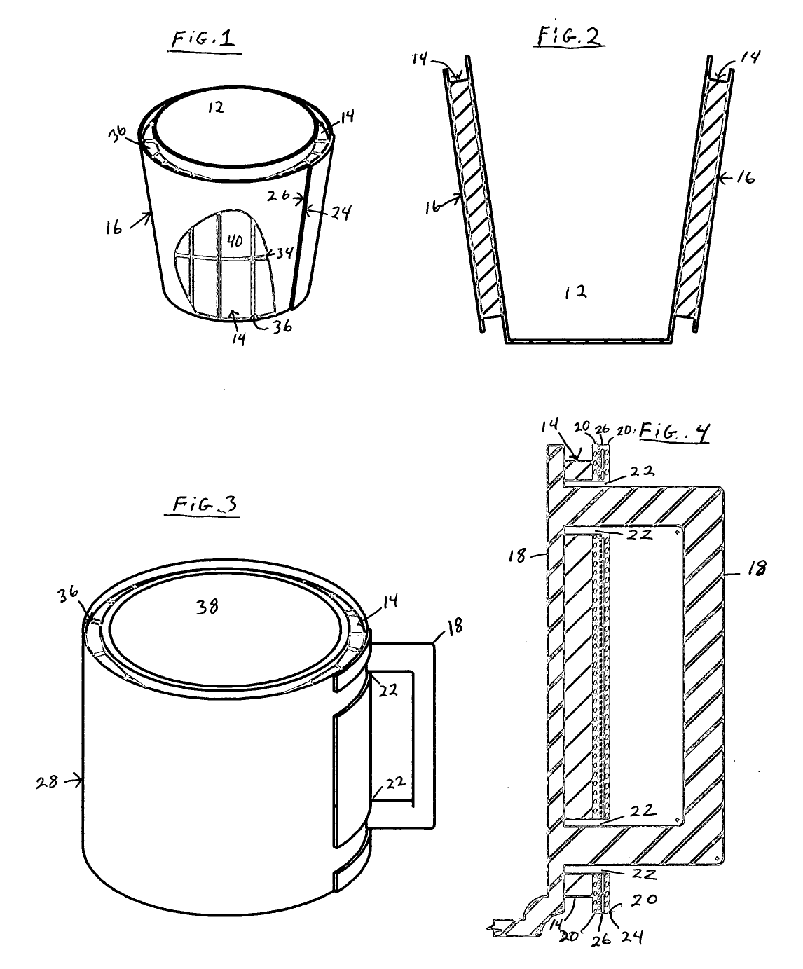

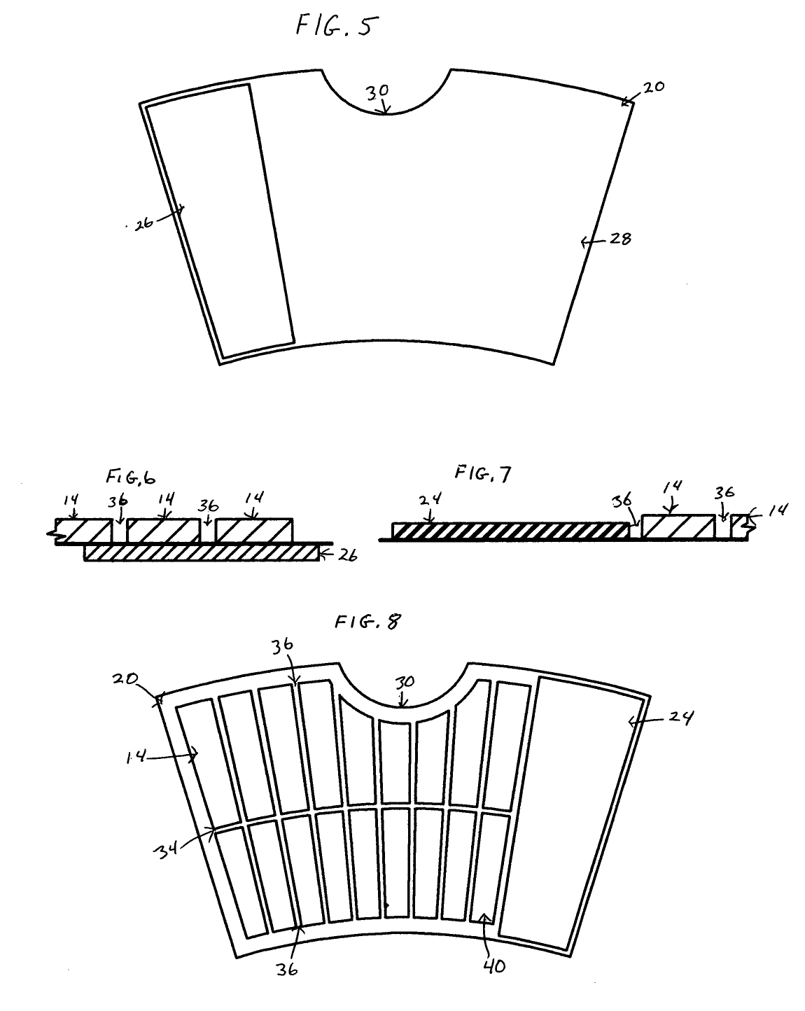

This invention incorporates a flexible resilient or non resilient layer of plastic 20. A multiple of injection molds 14 to lower temperature in containers 12 and pitchers 38 for sufficient periods of time. The Wrap 20 will have a hook of Velcro 24 and a loop of Velcro 26 on opposite sides and away from each other, and either will be sewed on or pressed with an adhesive for stability. This unit will be one hole piece so there is no assembly. This invention is closely related to U.S. Pat. No. 4,399,668 in the concept, by very different as you will see. The multitude of injection molds 14 are in different sections, having one on the bottom and one on the top shown in FIGS. 5 and 8. Separating them is a horizontal flexible divider 34, that I will now explain in the embodiment. The dividers 34 purpose is to separate the two rows of injection molds 14 shown in FIG. 8. Conventionally activating the top row of injection molds 14 wrapping around a cup 12 or a pitcher 38 allowing it conform to the shape of the container. The vertical flexible dividers 36 helps this in an event shown in FIGS. 1 and 3. One that uses this wrap 20 needs to make sure that the reverse side of the cells 28 shown on FIG. 5 are generally being grasped by the users hands.

Due to the preference of the user and then temperature, one can wrap with the injection molds 14 facing the opposite way for a less chilling effect. The hook of Velcro 24 and the loop of Velcro 26 would work either way, sincerely the loop of Velcro 26 and the hook of Velcro 24 is wide enough to accommodate various sizes of containers for a snug fit. There is a concave cut 30 shown in FIGS. 5 and 8 to display pouring and consumption with any obstruction. The plastic wrap 20 will need an expanse nylon cover 16 to slip over wrap 20 after it has been applied around the container. It may or may not include a zipper, snaps, or buttons which will allow the two ends to separate. The injection molds 14 could be between two and a half inches or three and a half inches in length. The width could be between three eighths and a half inch in width, depending on the size on the cup 12 and pitcher 38. There is an example of this application in figure one, two, and three.

The injection molds 14 can consist of many different kinds of coolants 40, such as de ionized water, ammonium nitrate, potassium nitrate, sodium chloride, calcium chloride, or refrigerant gel. Snapping the pack, which will allow the chemicals to activate, can be done by a person of any age. This plastic wrap 20 contains no handles for convenience. The injection molds 14 containing coolant 40 that are housed in the wrap 20 will stand approximately a half inch to five eighths of an inch high as displayed in figures six and seven. Generally when the wrap 20 conforms around the cup 12 or pitcher 28, it become a snug fit. The Velcro hook 24 and the Velcro loop 36 will come together and attach, providing the snug fit as shown in figures one and three.

The vertical flexible dividers 36 which are approximately an eighth inch wide provide the wrap 20 with ability to conform around the particular container.

When using this invention one will not have to remove the wrap 20 from any type of a refrigeration appliance, due to it being able stay in dry conditions until it is needed for usage.

An alternative application for the product is to be used at restaurants and bars. In FIGS. 3 and 4 you will see a pitcher 38 without a pouring spout that has the same layout as before, but it contains refrigerant gel coolant 40. Since this product has the refrigerant gel coolant 40, it will be able to be reused over and over again. This wrap 20 shown in FIGS. 3 and 4 is much bigger and wider, so it can conform to a container such as a pitcher 38. The only difference is the hook of Velcro 24 and the loop of Velcro 26 have knockouts 22 for the pitcher handles 18 as shown in FIG. 4. The vertical flexible dividers 36 are approximately an eighth inch wide and have the same the function as the application with cup 12 in figure one. The horizontal flexible divider 34 will play no role in the pitcher 38 application, since there is no non toxic coolant 40 in the injection molds that need to be released at strategic times. The injection molds 14 in this particular product will be approximately a quarter inch to five eighths in depth, and from a half inch to three quarters of an inch in width. These injection molds 14 will contain coolant 40 gel from manufacturing companies such as accurate manufacturing inc. This application will also have a concave 30 in the wrap 20 strategically placed under the spout of the pitcher 38 that is not shown.

1. A covering for a beverage container, comprising, in combination:
A flexiable single layer swathe tailored to orbit a beverage container, and leave an opening at its top to unmask the pouring end thereof: Said swathe having a multitude of injection molds providing a coolants layer contigous form other wherein envelope: Said swathe means for fastners sandwiching to conform stability: Said swathe bottom Exposed openly such that condensation can drain freely.
